(19) United States
(12) Patent Application Publication
(10) Pub. No.: US 2016/0097570 A1
(43) Pub. Date: Apr. 7, 2016

(54) Cooled bread and pastry container

(71) Applicant: Winifred Crawford, Long Beach, CA (US)

(72) Inventor: Winifred Crawford, Long Beach, CA (US)

(21) Appl. No.: 14/121,642

(22) Filed: Oct. 1, 2014

(51) Int. Cl. F25B 21/04; A21D 15/02

(52) U.S. Cl. CPC F25B 21/04; A21D 15/02

(57) ABSTRACT

A bread and pastry container is provided with a thermoelectric panel to set up convective currents which at their colder portions promote the condensation of humidity with the drier current portion then drawn through the container by the draft created around the hot side of the thermoelectric panel. A set of photovoltaic cells may be mounted on the container to provide the power for the thermoelectric panel.

### REFERENCE TO RELATED APPLICATIONS

The benefit of the earlier filing date of US Provisional Patent Application Ser. No. 61/961,102 filed on Oct. 4, 2013 is claimed for all the matter described herein.

### STATEMENT CONCERNING GOVERNMENT INTEREST

None.

### BACKGROUND OF THE INVENTION

1. Field of the Invention

The present invention relates to food containers, and more particularly to a baked products container provided with a thermoelectric panel having a cold portion thereof thermally extended as a pan spaced above its support surface to cool the trapped air volume therein to lower its relative humidity by convective heat exchange circulation.

2. Description of the Prior Art

The many strains of mold, and particularly its mildew subspecies, that comprise a part of the living process of each one of us are well known and even though their effect is generally benign the unsightly appearance of mold infested foodstuff and the potential of inclusion of the few slightly pathogenic strains (like aspergillus fumigatus and/or stachybotrus chartarum) in the infesting growth has resulted in a universal rejection of any food product marked by it. Simply, the fear of disease exposure masks any rational analyses and once any signs of mold or mildew are noted we simply discard the infested food. Of course, the resulting loss rate is manifest.

In each instance it is the pervasive nature of the mold or mildew spore that is at the heart of the problem, a life mechanism that obtains its success by growing and multiplying best in moist, hidden dark places that regularly escape cleaning attention and therefore persist virtually everyplace. It is this ubiquitous nature of the spore's preferred breeding grounds that defined the success of this life form, a breeding place that is dark, includes moisture and, of course, the necessary nutrient bed, a combination that is duplicated in virtually all bread and pastry containers including those in our home refrigerators.

In the past various solutions have been proposed which in one manner or another seek to minimize this combination of necessary conditions favoring the growth of mildew and mold, including those that expose the exterior surfaces of the bread article to cryogenic temperatures, exemplified in the teachings of U.S. Pat. No. 5,472,274 to Williams et al.; and U.S. Pat. No. 4,366,178 to Reynolds et al., including a light source within the container as in U.S. Pat. No. 5,433,140 to Ogee, and/or drying the trapped moisture content in the container as exemplified in U.S. Pat. No. 7,625,590 to Avis et al. and many others. Each of the foregoing, while suitable for the purposes intended, either entails substantial power levels to implement the lighting, drying or maintaining cryogenic temperatures that are not justified by the short consumption intervals of a loaf of bread or pastry article and that are easily defeated by periodic openings and closings of the container lid or door.

A bread and pastry container that passively reduces its internal temperature, and along with it its relative humidity, is therefore extensively desired and it is one such container that is disclosed herein.

### SUMMARY OF THE INVENTION

Accordingly, it is the general purpose and object of the present invention to provide a convective heat and humidity exchange system within a bread and pastry container powered by the illumination levels on the exterior thereof to passively reduce the temperature and relative humidity within its interior.

Other and further objects of the instant invention shall become apparent upon the examination of the teachings that follow in conjunction with the illustrations appended.

Briefly, these and other objects are accomplished within the present invention by providing a generally hollow, thermally insulating, bread and pastry storage container defined by an elongate upper cavity and a lower chamber separated from each other by a generally horizontal, thermally conducting pan spaced by supports at both ends thereof to form the lower chamber as it extends from an exteriorly directed cold side of a thermoelectric panel that exposes in a vertical vent through its upper cavity a portion of its hot side. Preferably that portion of the container that defines the upper cavity is formed as a generally concave, elongate lid pivoted at one end adjacent the thermoelectric panel to align its downwardly directed peripheral edge about the pan planform periphery as it is pivotally lowered to cover and enclose any bread or pastry articles resting on the pan. An array of photoelectric cells mounted as an adhered layer on the lid exterior provide power to the thermoelectric panel when the lid is exposed to light while air circulation through the lower and then through the upper chambers to vent out through a cutout next to the hot panel is enabled by a set of cutouts in the peripheral edge of the lid and a corresponding set of vents in the edge of the pan.

Thus a passively powered thermoelectric device is deployed within a container to set off convection flowsenabled by a set of edge cutouts in the peripheral edge of the lid that provides a pathway for the circulation of the air strata above the supporting surface into the lower chamber where it is cooled by its expansive thermal exchange with the pan to be then drawn into the upper cavity through an end cutout in the free end of the pan by the convection of its captured air through a lid gap adjacent the vertically aligned hot side of the panel. In this manner both sides of the thermoelectric device are useful in developing the circulation pattern by the convective exchanges at both the hot and the cold sides, with the large confined space of the lower chamber effectively reducing both the temperature of the bread or pastry on the pan and also reducing the relative humidity through the surrounding upper cavity where the bread and pastry are stored.

Notably, the narrow vertical spacing of the horizontally aligned thermally conductive pan above the supporting surface, as it extends from the cold side of the thermoelectric panel, will promote the condensation of any excess ambient humidity during those periods when the ambient humidity is high which can then be conveyed away out of the container by inclined condensate collection gutters at the lateral edges of the pan. Thus the air current circulated over the bread stored in the container on the conductive pan, as it is drawn or mixed with the upward draft along the panel's hot side, is at a reduced temperature and also humidity level as it passes over the bread, reducing the conditions that promote mold and mildew growth within the useful regions of the container. Of course, the same lowered temperature and humidity environment may then be also useful for storing other articles such as medicines and the like.

To facilitate both the insulation needs and also the convenience in the periodic cleaning of the container surfaces the structural portions thereof may be formed by known injection molding processes in which a polymeric material like styrene or polypropylene is first heated and then admixed with a chemical foaming agent or compressed gas thereafter. This combination may then be injected into molds and as the expanding molten mix fills the void of the mold cavity the contact with the colder mold surfaces results in a lower local foaming rate, transferring the gas expansion process towards the higher temperature inner regions which therefore result in an unfoamed, homogeneous and solid exterior skin while the hotter interior volume continues the foaming process by creating gas bubbles and accepting the transfer of those from the exterior cooler regions. Thus an easily cleaned, moisture impervious structure can be obtained by known techniques utilizing chemical foaming agents such as those obtained from commercial sources under the mark or style ‘FOAMAZOL’ 198 by Bergen Int'l, LLC, 411 State Highway 17 South, Suite 100, Hasbrouck Heights, N.J. 07604.

Similarly, a complementing set of thermoelectric panel matched in their power consumption with the power obtained from a particular array of photovoltaic power devices is also well known and conveniently obtainable by the simple arithmetic of the Peltier junctions that define the thermoelectric panel and the series and parallel connections of commercially available mono or poly-crystalline photovoltaic cells. Thus the foregoing benefits are easily obtained by known techniques utilizing known formulations or components.

### BRIEF DESCRIPTION OF THE DRAWINGS

FIG. 1 is a perspective illustration of the inventive bread container in its open configuration;

FIG. 2 is yet another perspective illustration illustrating the inventive bread container in its fully closed configuration;

FIG. 3 is a sectional side view of the inventive bread container taken along line 3-3 in FIG. 2 illustrating the air currents developed in the course of the powered operation thereof; and

FIG. 4 is a circuit diagram of a thermoelectric panel connected to a photoelectric array for developing the temperature and humidity differentials useful in the course of operation of the inventive bread container.

### DESCRIPTION OF THE PREFERRED EMBODIMENT

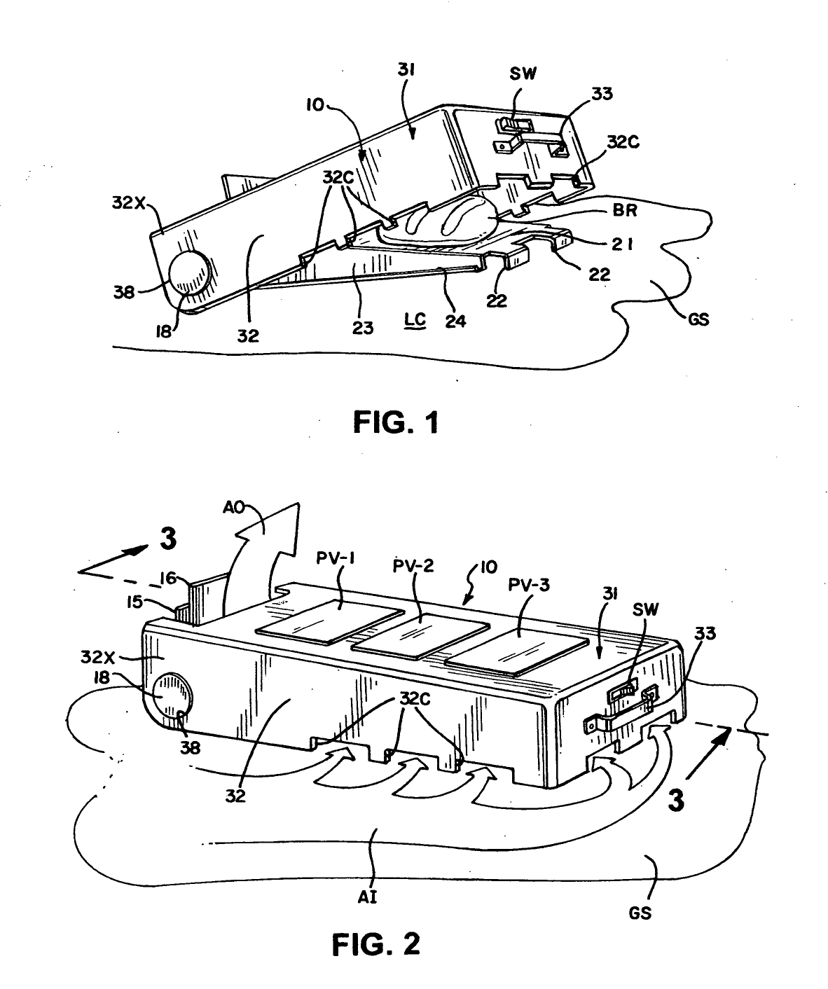

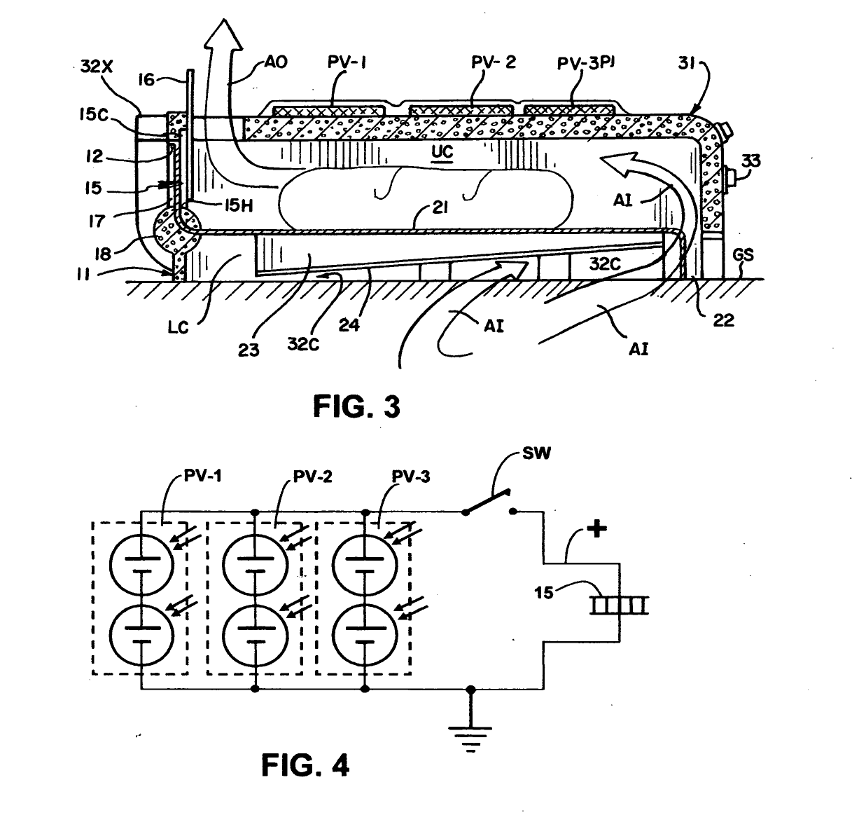

As in FIGS. 1 through 4 the inventive bread (and pastry) container, generally designated by the numeral 10, comprises a vertically aligned polymeric mount structure 11 provided with a rectangular aperture 12 within which a commercially vended thermoelectric panel 15 is conformingly fitted. In accordance with the observations by Jean Peltier and Jonathan Seeberg such panels are characterized by arrays of junctions which produce a temperature difference between the panel surfaces in accordance with the electrical voltage applied so that each such panel is characterized by a hot side 15H and a cold side 15C. In this form the panel 15 together with the support structure 11 are characterized by hot and cold sides aligned to expose its cold side to the adjacent exterior.

To achieve the convective advantages described herein a vertically aligned thermally conductive surface 16 is fixed in intimate contact with the hot panel side 15H to extend upwardly beyond the upper edge of the structure 11 while a similar thermally conductive strip 17 aligned for intimate contact with the cold side 15C of the panel extends downwardly to be turned beneath the panel within a turning angle formed in a transverse pivot post 18 aligned in spaced alignment above the supporting ground surface GS. As thus turned and supported within structure 11 the conductive strip then extends as a generally horizontal elongate pan 21 that at its free end is provided with bent down legs 22 that again are supported on the surface GS. In this manner a lower chamber LC is defined between the pan 21 and the ground surface GS that is chilled by the heat transfer through the pan 21 that then becomes strip 17 in intimate contact with the cold side 15C.

Those skilled in the art will appreciate that the chilled temperatures of the surfaces that enclose the lower chamber LC will invariably promote condensation of any excess humidity thereon and to promote the conveyance of this condensate away from the main pathways of convective exchange the pan 21 includes downwardly directed edge strips 23 along the lateral edges thereof that include collection troughs 24 that are inclined towards the ground surface GS adjacent the support structure 11. The condensate that may be thus collected may then be periodically wiped away, or may be absorbed in a fibrous structure (not shown).

In this form the combination of the vertical support structure 11 and the horizontal pan 21 extending therefrom may be pivotally engaged at the ends of the pivot post 18 within correspondingly fitted pivot openings 38 at the ends of opposing side extensions 32X of a generally concave lid assembly 31 formed to enclose the planform of the pan 21 within a peripheral strip 32. The free end of the lid assembly 31 can then be periodically lifted by way of a handle 33 to allow access to any baked products BR resting on pan 21. An array of photovoltaic cells PV-1, PV-2 and PV-3 adhesively mounted on the lid exterior, when connected by switch SW, is then useful in generating the necessary electrical power to drive the thermoelectric panel 15.

When lowered pivotally onto the ground surface GS to define an upper chamber UC above the pan 21 convective air current access into the lower chamber LC and then through the gap between legs 22 into this upper chamber is obtained by way of a plurality of edge cutouts 32C in the edge strip 32 defining convective pathways AI for the movement of air into the container interior. At the same time the gap between the extensions 32X adjacent the hot side 15H of panel 15, as amplified by the conductive surface 16 in contact therewith, provide the necessary outflow draft AO to drive the continuing convection process with the necessary insulation levels obtained by way of the foamed injection process described above insuring smooth, well insulated, surfaces in the upper chamber confining most of the condensation to the lower chamber.

In this manner a passively implemented baked products container structure is implemented in a manner that insures convective flows that keep the stored matter both at a lower temperature and also at a lower moisture level. As result much of the pathogen growth is inhibited in a structure that is easily disassembled and then cleaned to further limit the initial seed levels of mold and mildew, inhibiting the regrowth even further.

Obviously many modifications and variations of the instant invention can be effected without departing from the spirit of the teachings herein. It is therefore intended that the scope of the invention be determined solely by the claims appended hereto.

It is claimed:

1. A storage assembly useful for storing baked products, comprising:
a generally planar mount structure including a support base conformed to support said mount structure in a generally vertical alignment;
a thermoelectric panel defined by a cold side and a hot side attached to said mount structure to extend substantially vertically above said base;
a generally elongate thermally conductive pan defined by a first end and a second end, said first end extending through said mount structure subjacent said panel for intimate contact with said cold side thereof and said second end extending substantially horizontally in a generally opposite direction to said first end; and
an elongate lid pivotally engaged at one end thereof to said mount structure for pivotal articulation thereabout to enclose said pan.

2. A storage assembly according to claim 1, further comprising:
a source of electrical power connected across said thermoelectric panel in a polarized connection to render said cold and hot sides operative.

3. A storage assembly according to claim 2, further comprising:
a thermally conductive extension attached to said mount structure in intimate contact with said hot side.

4. A storage assembly according to claim 3, wherein:
said lid is formed of a thermally insulating material structure.

5. A storage assembly according to claim 4, wherein:
said lid includes a ventilation cutout adjacent said thermally conductive extension.

6. A storage assembly according to claim 2, wherein:
said source of electrical power includes a photovoltaic cell.

7. A storage assembly according to claim 6, further comprising:
a thermally conductive extension attached to said mount structure in intimate contact with said hot side.

8. A storage assembly according to claim 7, wherein:
said lid is formed of a thermally insulating material structure.

9. A storage assembly according to claim 8, wherein:
said lid includes a ventilation cutout adjacent said thermally conductive extension.

10. A storage assembly according to claim 9, wherein:
said photovoltaic cell is mounted on said lid.

11. A storage assembly according to claim 6, wherein:
said pan includes condensate conveying means for conveying condensate towards said mount structure
